(19) United States
(12) Patent Application Publication
(10) Pub. No.: US 2008/0144139 A1
(43) Pub. Date: Jun. 19, 2008

(54) SCANNING DISPLAY APPARATUS AND METHOD FOR CONTROLLING OUTPUT TIME OF LIGHT SOURCES

(75) Inventor: In-Jae Yeo, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 11/877,600

(22) Filed: Oct. 23, 2007

(30) Foreign Application Priority Data
Dec. 18, 2006 (KR) 1020060129190

(51) Int. Cl. H04N 1/46

(52) U.S. Cl. 358/509

(57) ABSTRACT

An aspect of the present invention provides a scanning display apparatus capable of adjusting an output time of a light source. The apparatus can comprise a light modulator configured to modulate incident light in accordance with a driving signal and output modulated light corresponding to a one-dimensional linear image; a driving circuit configured to convert an inputted image control signal to the driving signal and send the driving signal to the light modulator; a scanner configured to scan modulated light from the light modulator onto a screen by rotating in accordance with a scanner control signal, thereby displaying a two-dimensional color image; a plurality of mono-color light sources configured to provide the light modulator with the incident light; a plurality of light source output control parts configured to control an output power and an output time of the mono-color light source in accordance with a light source control signal; and an image control part configured to receive an image signal, provide the light source output control part with the light source control signal, and provide the scanner and the driving circuit with the scanner control signal and the image control signal, thereby controlling an image projection by the light modulator, the light source control signal controlling the output power and the output time of one or more of the plurality of mono-color light sources, and the scanner control signal and the image control signal being synchronized with the light source control signal. A display apparatus and a display method can take full advantage of output of a light source by controlling output time of the light source, thereby capable of improving the brightness of a picture.

### CROSS-REFERENCE TO RELATED APPLICATIONS

This application claims the benefit of Korean Patent Application No. 10-2006-0129190 filed with the Korean Intellectual Property Office on Dec. 18, 2006, the disclosure of which is incorporated herein by reference in their entirety.

### BACKGROUND

1. Technical Field

The present invention relates to a display apparatus using a light modulator, more particularly to a scanning display apparatus that generates a two dimensional image by scanning light (one dimensional image) modulated by a one dimensional light modulator, and can adjust output demand according to a light source by varying scanning time per color.

2. Description of the Related Art

With the introduction of optical signal processing, it became easier to process large amount of data fast and parallel. Also, optical modulation has been applied to bi-phase filters, optical logic gates, optical amplifiers, optical elements and light modulators. Especially, the light modulator is being used in fields such as optical memories, optical displays, printers, optical interconnections, holograms, optical scanners, etc.

Such an optical scanner is employed in an image forming apparatus, for example, laser printers, LED printers, electronic photocopiers, word processors, projectors, etc.

Recently, as projection televisions have been developed, the optical scanner is also used in the projection TV to project beams to a screen.

A scanning display apparatus includes a light modulator and a scanner. The light modulator emits modulated light by modulating light incident from a light source. Here, the light modulator accommodates a plurality of micro-mirrors arranged in a row, and each micro-mirror is responsible for one pixel, so that produces modulated light corresponding to a one dimensional image (vertical scanning line or horizontal scanning line).

A scanner scans a plurality of one dimensional images sequentially, creating a two dimensional image on a screen. In order to represent a color image, the scanning display apparatus should use a laser diode or a laser composed of individual color light sources. However, the overall brightness of the image is decided only by one of the individual color light sources while other light sources do not exercise their full capability.

Therefore, it is encouraged to make the best use of all the light sources in order to enhance the brightness. However, the conventional art has a problem that the light sources have an equal frame time, so that one of the light source controls the brightness of picture.

### SUMMARY

Accordingly, the invention provides a display apparatus and a display method that can take full advantage of output of a light source by controlling output time of the light source, thereby capable of improving the brightness of a picture.

Also, the invention provides a display apparatus and a display method that take full advantage of by controlling output time of a light source, thereby capable of improving the brightness of a picture.

An aspect of the present invention provides a scanning display apparatus capable of adjusting an output time of a light source. The apparatus can comprise a light modulator configured to modulate incident light in accordance with a driving signal and output modulated light corresponding to a one-dimensional linear image; a driving circuit configured to convert an inputted image control signal to the driving signal and send the driving signal to the light modulator; a scanner configured to scan modulated light from the light modulator onto a screen by rotating in accordance with a scanner control signal, thereby displaying a two-dimensional color image; a plurality of mono-color light sources configured to provide the light modulator with the incident light; a plurality of light source output control parts configured to control an output power and an output time of the mono-color light source in accordance with a light source control signal; and an image control part configured to receive an image signal, provide the light source output control part with the light source control signal, and provide the scanner and the driving circuit with the scanner control signal and the image control signal, thereby controlling an image projection by the light modulator, the light source control signal controlling the output power and the output time of one or more of the plurality of mono-color light sources, and the scanner control signal and the image control signal being synchronized with the light source control signal.

The mono-color light source can produce one color among red, green, and blue.

The mono-color light source can produce one color among four different colors.

The image control part can comprise an image data synchronization signal output part configured to generate and output the image control signal, the image control signal deciding an output starting time and an output period of the image data for each color in correspondence with the image signal and the output power of the plurality of mono-color light sources; a light source output control part configured to output the light source control signal controlling the output power and turning on and turning off of the plurality of mono-color light sources in correspondence with the output starting time and the output period of the image data for each color; and a scanner output control part configured to output the scanner control signal in correspondence with the output starting time and the output period of the image data for each color, the scanner control signal controlling a rotation angle and a rotation velocity of the scanner.

The image data synchronization signal output part can keep the total of the output times of the plurality of mono-color light sources constant by relatively increasing the output time of the mono-color light source outputting a relatively lower output power among the plurality of mono-color light sources, and decreasing the output time of the other mono-color light sources.

The image data synchronization signal output part can increase the output power of the mono-color light sources, of which the output time is relatively decreased, by a rate corresponding to the decrease of the output time.

The light modulator can comprise a plurality of micro-mirrors arranged in a row and configured to reflect the incident light; and a driving part configured to drive the micro-mirrors according to the driving signal, each micro-mirror being responsible for one pixel of the screen.

Another feature of the present invention provides a scanning display method of displaying a two-dimensional color image on a screen by scanning one-dimensional linear images. The display method can comprise selecting among a plurality of mono-color light sources a mono-color light source limiting the luminance of the two-dimensional color image; increasing an output time of the selected mono-color light source and decreasing an output time of other mono-color light sources such that the total output time remains the same; generating and outputting a light source control signal, an image control signal, and a scanner control signal in correspondence with the output times; and displaying the two dimensional color image by controlling the plurality of mono-color light sources, a light modulator, and a scanner according to the light source control signal, the image control signal, and the scanner control signal.

Selecting the mono-color light source can comprise selecting a mono-color light source limiting the luminance of the two dimensional color image using maximum effective powers and output power demands of the plurality of mono-color light sources.

Generating and outputting the light source control signal, the image control signal, and the scanner control signal can comprise generating and outputting the light source control signal configured to increase an output power of the mono-color light source, of which an output time is decreased, by a rate corresponding to the decrease in the output time.

Generating and outputting the light source control signal, the image control signal, and the scanner control signal can comprise generating and outputting the image control signal configured to decide an output starting time and output period of an image data of a color corresponding to the mono-color light source, according to the output times.

Generating and outputting the light source control signal, the image control signal, and the scanner control signal can comprise generating and outputting the scanner control signal configured to control a rotation angle and a rotation velocity of the scanner according to the output times.

Additional aspects and advantages of the present general inventive concept will be set forth in part in the description which follows, and in part will be obvious from the description, or may be learned by practice of the general inventive concept.

### BRIEF DESCRIPTION OF THE DRAWINGS

These and other features, aspects, and advantages of the present invention will become better understood with regard to the following description, appended claims, and accompanying drawings where:

FIG. 1 illustrates a scanning display apparatus using a light modulator.

FIG. 2A is a perspective view of a micro-mirror included in a light modulator using piezoelectric elements, applicable to an embodiment of the invention.

FIG. 3b is a perspective view of another micro-mirror included in a light modulator using piezoelectric elements, applicable to an embodiment of the invention.

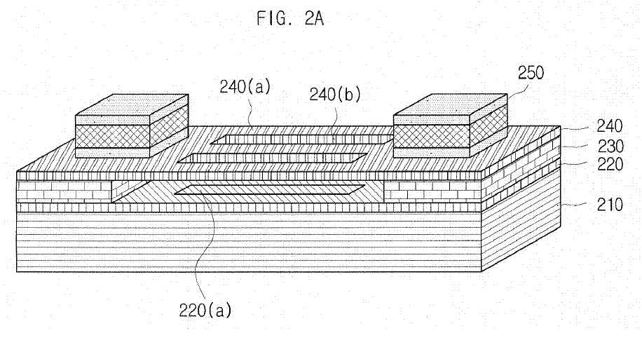

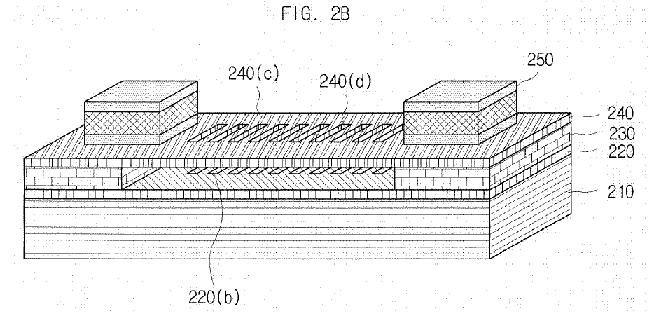

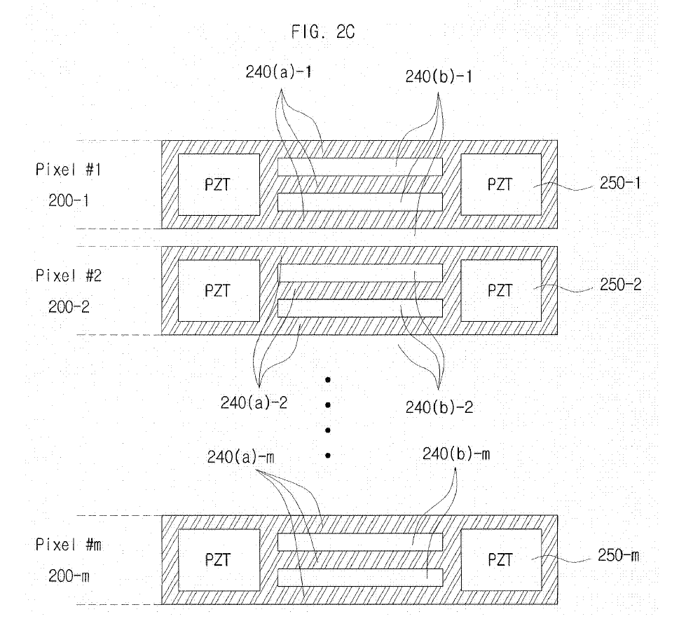

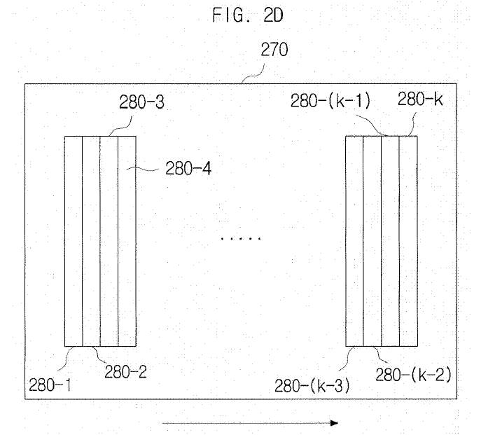

FIG. 2C is a plan view of a light modulator having a plurality of micro mirrors as shown in FIG. 2A.

FIG. 2D is a schematic diagram illustrating an image generated on a screen by means of a diffraction type light modulator array applicable to an embodiment of the invention.

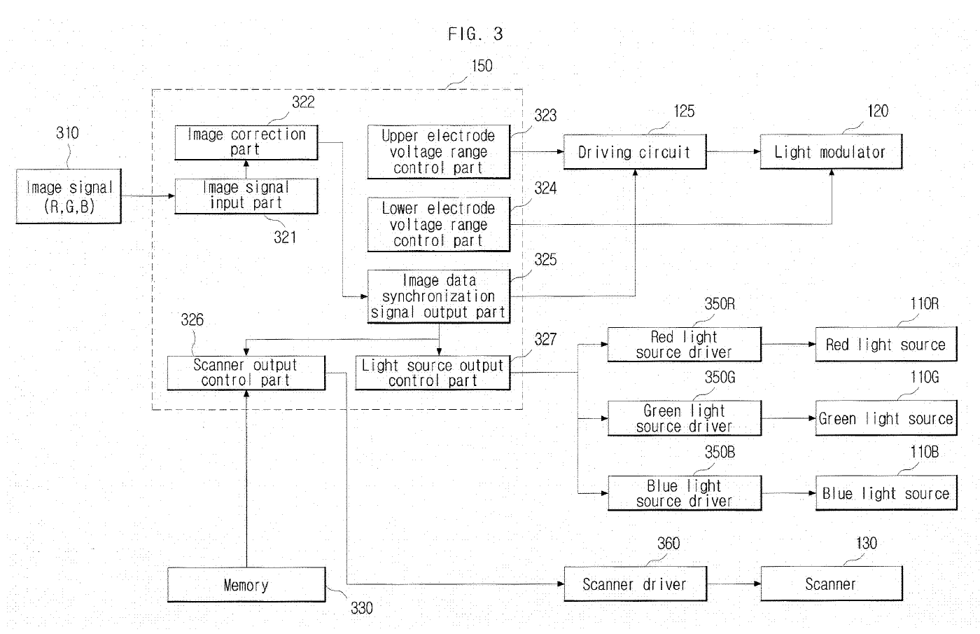

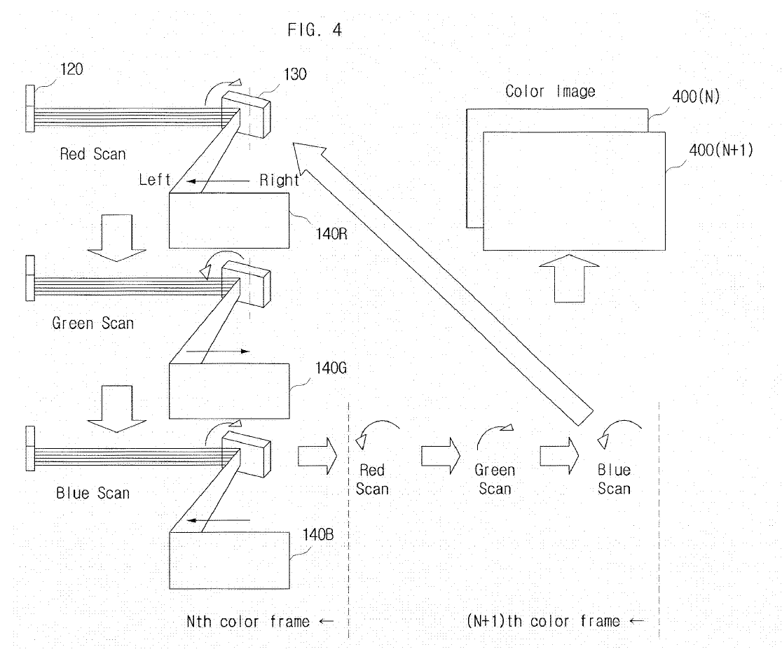

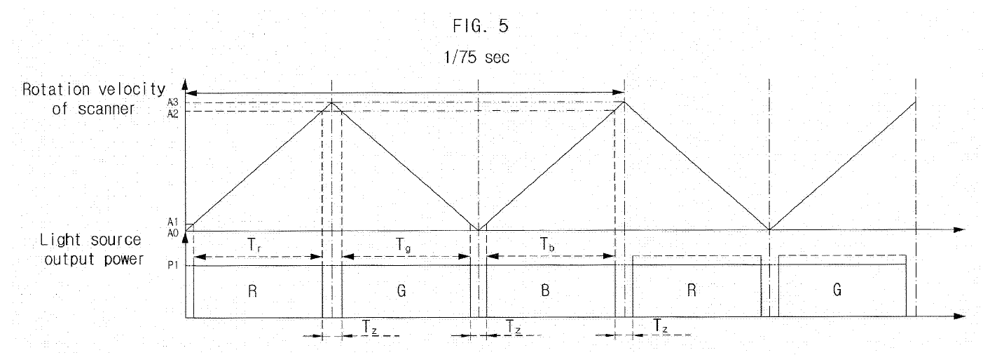

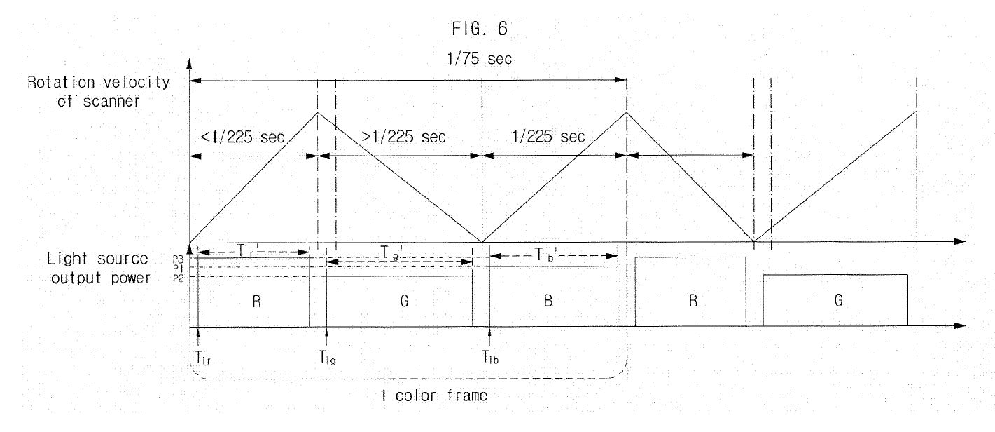

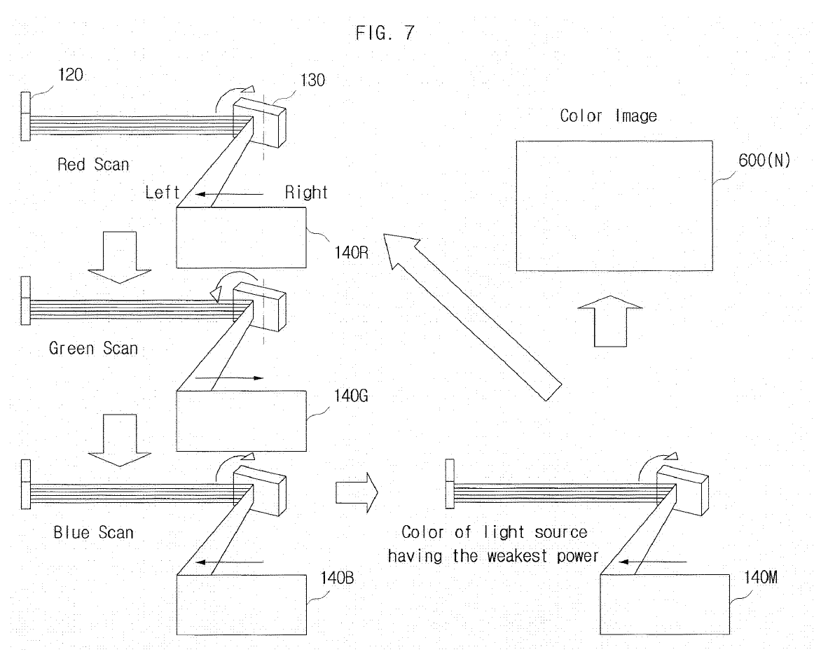

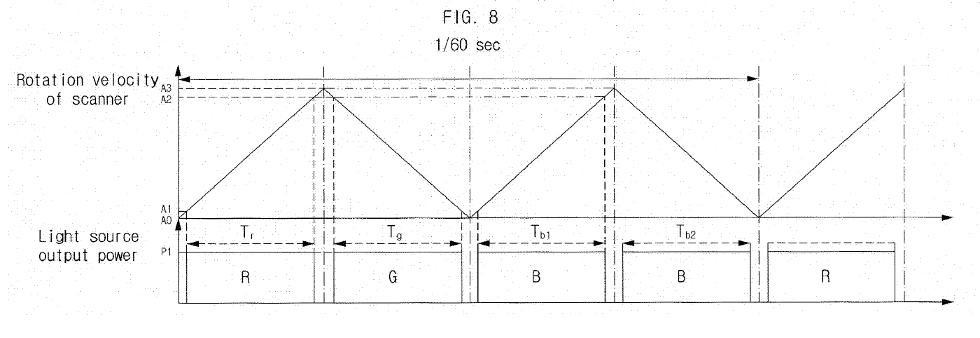

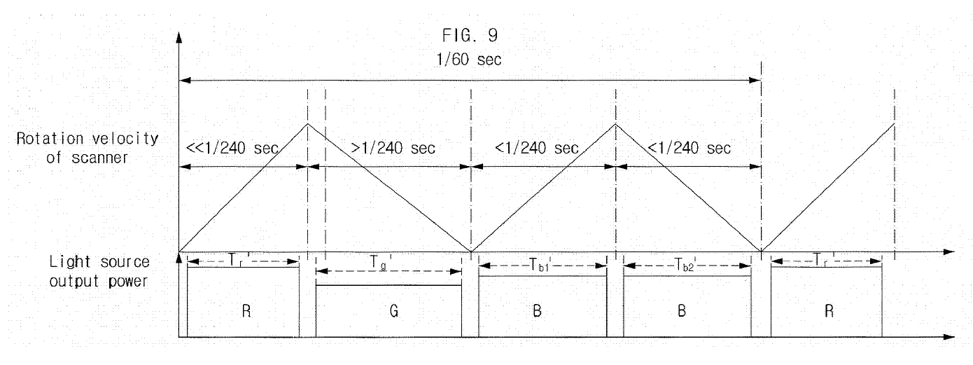

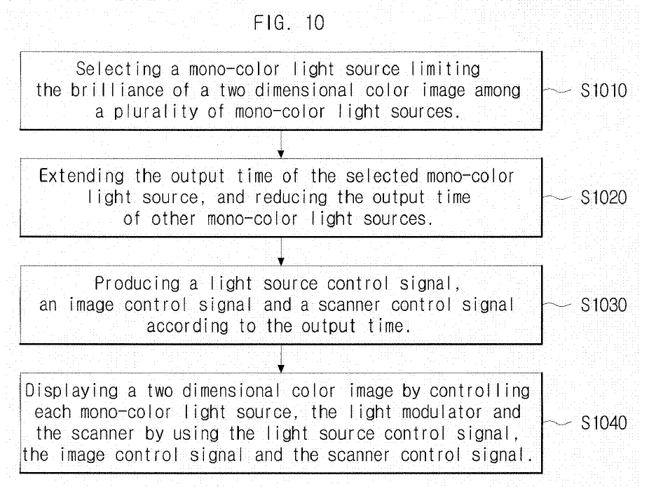

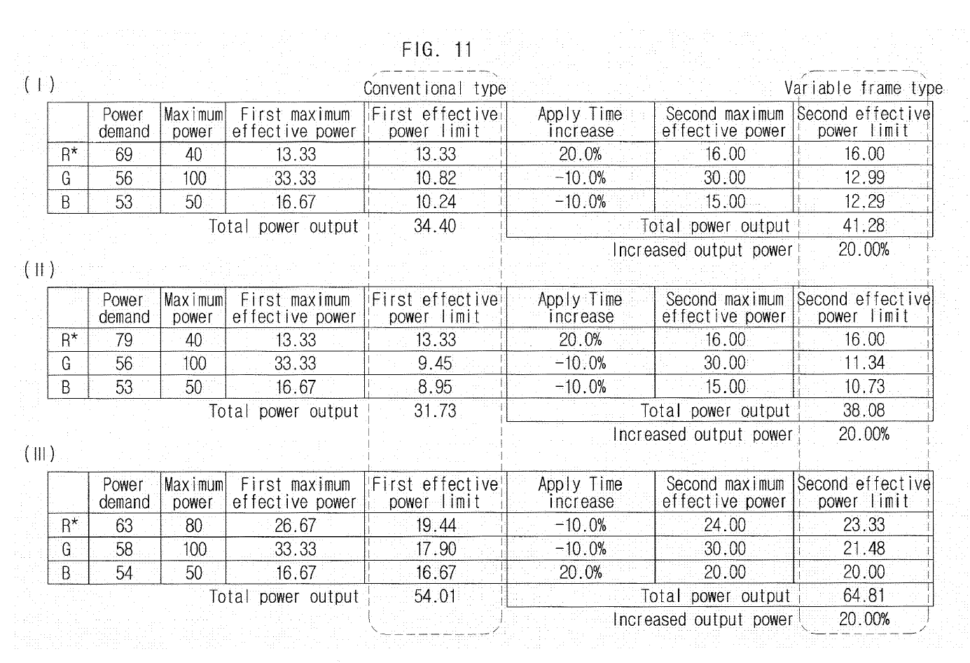

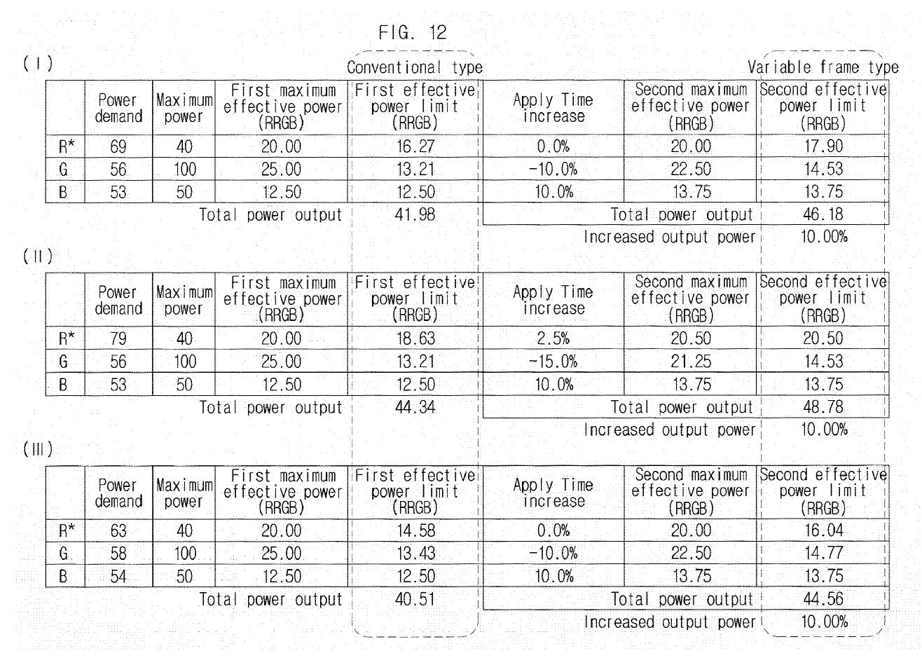

FIG. 3 is a block diagram of a part of the scanning display apparatus.

FIG. 4 illustrates a three subframe scanning display method that has variable output time according to color.

FIG. 5 is a diagram showing signals applied to a scanner and a light source in the conventional three subframe scanning display method.

FIG. 6 is a diagram showing signals applied to a scanner and a light source in an embodiment of the present invention.

FIG. 7 shows a four subframe scanning display method that has variable output time according to color.

FIG. 8 is a diagram showing signals applied to a scanner and a light source in the typical four subframe scanning display method.

FIG. 9 is a diagram showing signals applied to a scanner and a light source in an embodiment of the present invention.

FIG. 10 is a flowchart of a scanning display method according to an embodiment of the present invention in which the output time of the light source is variable.

FIG. 11 shows tables in which the light efficiency is compared before and after the three subframe scanning display method having variable output time according to color is applied.

FIG. 12 shows tables in which the light efficiency is compared before and after the four subframe scanning display method having variable output time according to color is applied.

### DETAILED DESCRIPTION

Hereinafter, embodiments of the invention will be described in more detail with reference to the accompanying drawings. In the description with reference to the accompanying drawings, those components are rendered the same reference number that are the same or are in correspondence regardless of the figure number, and redundant explanations are omitted.

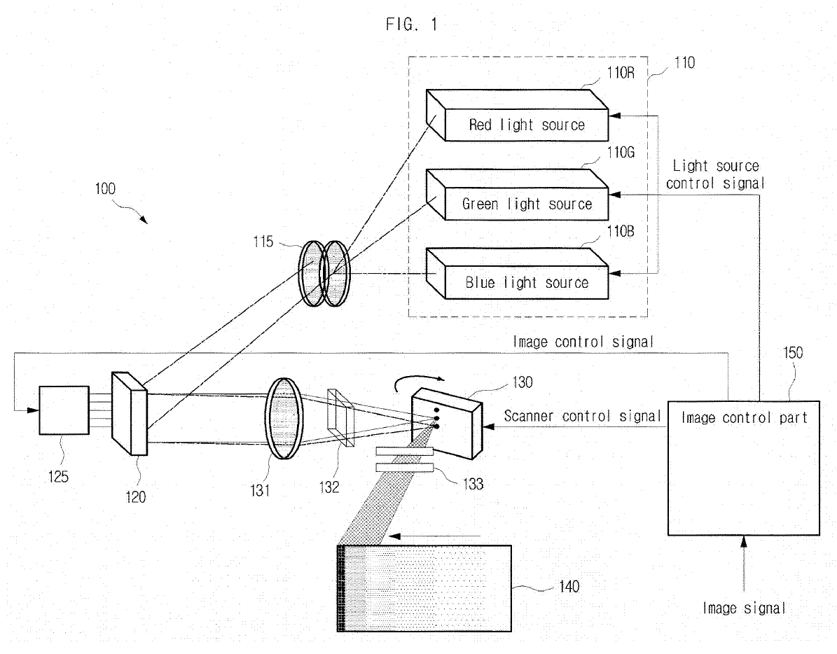

FIG. 1 illustrates a scanning display apparatus using a light modulator. Referring to FIG. 1, the scanning display apparatus 100 includes a light source 110, a light modulator 120, a driving circuit 125, a scanner 130 and an image control part 150.

The light source 110 emits light, enabling an image to be projected on a screen 140. The light source 110 is composed of a red light source 110R, a green light source 110G and a blue light source 110B producing red light, green light and blue light, respectively. However, the light source 110 can also be composed of other color light sources as long as the combination of colors represents a full color image. The light source 110 may be a laser, an LED or a laser diode.

A light source control signal from the image control part 150 controls the light source 110 to be turned on or off. When one of the color light sources is turned on, the other color light sources are turned off.

An illumination system 115 is disposed between the light source 110 and the light modulator 120, and reflects light sent from the light source 110 in such an angle that the reflected light is directed to the light modulator 120.

The light modulator 120 sends out modulated light in accordance with a driving signal provided by the driving circuit 125. The light modulator 120 is composed of a plurality of micro-mirrors arranged in a row, and deals with image information with respect to 1-dimensional images of vertical or horizontal scanning lines, while each micro-mirror deals with one pixel constituting the vertical or horizontal scanning line. By deforming the micro-mirror, the light modulator 120 produces modulated light.

The number of the micromirrors may be equal to or a multiple of the number of the pixels constituting the vertical or horizontal scanning lines. The modulated light contains image information of the vertical or horizontal lines (for example, brilliance values for each pixel), and is composed of 0 order diffracted light (namely, reflected light), +n order diffracted light, and −n order diffracted light (n is a natural number).

The driving circuit 125 provides the light modulator 120 with a driving signal controlling the brilliance of the modulated light, which is outputted according to an image control signal from the image control part 150. Such a driving signal may be a driving voltage or a driving current.

A concentration system 131 enables the modulated light from the light modulator 120 to travel to the scanner 130. The concentration system 131 may include one or more lens, which magnify or reduce the modulated light according to the size of the light modulator 120 and the scanner 130.

The modulated light incident to the scanner 30 is reflected at an angle to the screen 140. Here, the reflection angle is determined by a scanner control signal provided by the image control part 150. The scanner control signal rotates the scanner 130, in synchronization with the image control signal, to such a position that the modulated light can be projected to a location of the screen 140 corresponding to the image control signal. The scanner 130 may be a polygon mirror, a rotation bar or a galvano mirror.

The modulated light from the light modulator 120 may be 0-order diffracted light, +n-order diffracted light or −n-order diffracted light. Each diffracted light is projected onto the screen 140 by the scanner 130. A slit 133 is disposed so that a required diffracted light can be selectively projected onto the screen 140.

A projection system 132 includes a projection lens, and allows the modulated light from the light modulator 120 to be projected onto the scanner 130.

The image control part 150 provides the image control signal, the scanner control signal and the light source control signal to the driving control circuit 125, the scanner 130 and the light source 110, respectively. The control signal, the scanner control signal and the light source control signal are synchronized to display an image frame on the screen 140.

The image control part 150 is provided with an image signal corresponding to one frame, and controls the light source 110, the light modulator 120 and the scanner 130 according to the image signal. The image control part 150 provides the driving circuit 125 with the image control signal containing brilliance information for all the pixels in one frame, and controls the rotation angle or the rotation velocity of the scanner 130 such that the vertical scanning line (or the horizontal scanning line) is projected to a location of the screen 140 corresponding to the image control signal. The control signals generated in the image control part 150 will later be described in detail.

The following describes the light modulator 120 applicable to the invention.

The light modulator can be divided mainly into a direct type, which directly controls the on/off state of light, and an indirect type, which uses reflection and diffraction. The indirect type may be further divided into an electrostatic type and a piezoelectric type. Light modulators are applicable to the embodiments of the invention regardless of the operation type.

An electrostatic type grating light modulator as disclosed in U.S. Pat. No. 5,311,360 includes a plurality of equally spaced-apart deformable reflective ribbons having reflective surfaces and suspended above the upper part of the substrate.

First, an insulation layer is deposited onto a silicon substrate, followed by the deposition of a sacrificial silicon dioxide film and a silicon nitride film. The silicon nitride film is patterned from the ribbons, and portions of the silicon dioxide film are etched so that the ribbons are maintained by the nitride frame on the oxide spacer layer.

The grating amplitude, of such a modulator limited to the vertical distance d between the reflective surfaces of the ribbons and the reflective surface of the substrate, is controlled by supplying voltage between the ribbons (the reflective surface of the ribbon, which acts as the first electrode) and the substrate (the conductive film at the bottom portion of the substrate, which acts as the second electrode).

FIG. 2A is a perspective view of a micro-mirror included in a light modulator using piezoelectric elements, applicable to an embodiment of the invention, and FIG. 2B is a perspective view of another micro-mirror included in a light modulator using piezoelectric elements, applicable to an embodiment of the invention. In FIGS. 2a and 2b are illustrated micro-mirrors, each including a substrate 210, an insulation layer 220, a sacrificial layer 230, a ribbon structure 240, and piezoelectric elements 250.

The substrate 210 is a commonly used semiconductor substrate, and the insulation layer 220 is deposited as an etch stop layer. The insulation layer 220 is formed from a material with a high selectivity to the etchant (the etchant is an etchant gas or an etchant solution) that etches the material used as the sacrificial layer. Here, reflective layers 220(a), 220(b) may be formed on the insulation layer 120 to reflect incident beams of light.

The sacrificial layer 230 supports the ribbon structure 240 such that the ribbon structure is spaced by a particular gap from the insulation layer 220, and forms a space in the center.

The ribbon structure 240 creates diffraction and interference in the incident light to provide optical modulation of signals as described above. The form of the ribbon structure 240 may be composed of a plurality of ribbon shapes according to the electrostatic type, and may comprise a plurality of open holes 240(b), 240(d) in the center portion of the ribbons according to the piezoelectric type. The piezoelectric elements 250 control the ribbon structure 240 to move vertically, according to the degree of up/down or left/right contraction and expansion generated by the difference in voltage between the upper and lower electrodes. Here, the reflective layers 220(a), 220(b) are formed in correspondence with the holes 240(b), 240(d) formed in the ribbon structure 140.

For example, in the case where the wavelength of a beam of light is λ, when there is no power supplied or when there is a predetermined amount of power supplied, the gap between an upper reflective layer 240(a), 240(c) formed on the ribbon structure and the insulation layer 220, on which is formed a lower reflective layer 220(a), 220(b), is equal to nλ/2 (wherein n is a natural number). Therefore, in the case of a 0-order diffracted (reflected) beam of light, the overall path length difference between the light reflected by the upper reflective layer 240(a), 240(c) formed on the ribbon structure and the light reflected by the insulation layer 220 is equal to nλ, so that constructive interference occurs and the diffracted light is rendered its maximum luminosity. In the case of +1st or −1st order diffracted light, however, the luminosity of the light is at its minimum value due to a destructive interference.

Also, when an appropriate amount of power is supplied to the piezoelectric elements 250, other than the supplied power mentioned above, the gap between the upper reflective layer 240(a), 240(c) formed on the ribbon structure and the insulation layer 220, on which is formed the lower reflective layer 220(a), 220(b), becomes (2n+1)λ/4 (wherein n is a natural number). Therefore, in the case of a 0-order diffracted (reflected) beam of light, the overall path length difference between the light reflected by the upper reflective layer 240(a), 240(c) formed on the ribbon structure and the light reflected by the insulation layer 220 is equal to (2n+1)λ/2, so that destructive interference occurs, and the diffracted light is rendered its minimum luminosity. In the case of +1 or −1 order diffracted light, however, the luminosity of the light is at its maximum value due to constructive interference. As a result of such interference, the light modulator can load signals on the beams of light by controlling the quantity of the reflected or diffracted light.

While the foregoing describes the cases in which the gap between the ribbon structure 240 and the insulation layer 220, on which is formed the lower reflective layer 120(a), 120(b), is nλ/2 or (2n+1)λ/4, it is obvious that a variety of embodiments may be applied with regards the present invention which are operated with gaps that allow the control of the interference by diffraction and reflection.

The descriptions below will focus on the type of light modulator illustrated in FIG. 2A described above. Also, 0-order diffracted (reflected) light, +n-order diffracted light, −n order diffracted light (n is a natural number) is collectively referred to as modulated light.

FIG. 2C is a plan view of a light modulator having a plurality of micro mirrors as shown in FIG. 2A.

Referring to FIG. 2C, the light modulator is composed of an m number of micromirrors 100-1, 100-2, . . . , 100-m, each responsible for pixel #1, pixel#2, . . . , pixel #m. The light modulator deals with image information with respect to 1-dimensional images of vertical or horizontal scanning lines (Here, it is assumed that a vertical or horizontal scanning line consists of an m number of pixels.), while each micromirror 100-1, 100-2, . . . , 100-m deals with one pixel among the m pixels constituting the vertical or horizontal scanning line. Thus, the light reflected and diffracted by each micromirror is later projected by an optical scanning device as a 2-dimensional image on a screen. For example, in the case of VGA 640*480 resolution, modulation is performed 640 times on one surface of an optical scanning device (not shown) for 480 vertical pixels, to generate 1 frame of display per surface of the optical scanning device. Here, the optical scanning device may be a polygon mirror, a rotating bar, or a galvano mirror, etc.

While the description below of the principle of optical modulation concentrates on pixel #1, the same may obviously apply to other pixels.

In the present embodiment, it is assumed that the number of holes 240(b)-1 formed in the ribbon structure 240 is two. Because of the two holes 240(b)-1, there are three upper reflective layers 240(a)-1 formed on the upper portion of the ribbon structure 240. On the insulation layer 220, two lower reflective layers are formed in correspondence with the two holes 240(b)-1. Also, there is another lower reflective layer formed on the insulation layer 220 in correspondence with the gap between pixel #1 and pixel #2. Thus, there are an equal number of upper reflective layers 240(a)-1 and lower reflective layers per pixel, and as discussed with reference to FIG. 2A, it is possible to control the luminosity of the modulated light using 0-order diffracted light or ±1-order diffracted light.

FIG. 2D is a schematic diagram illustrating an image generated on a screen by means of a diffraction type light modulator array applicable to an embodiment of the invention.

Illustrated is a display 280-1, 280-2, 280-3, 280-4, . . . , 280-(k-3), 280-(k-2), 280-(k-1), 280-k) generated when beams of light reflected and diffracted by an m number of vertically arranged micromirrors 200-1, 200-2, . . . , 200-m are reflected by the optical scanning device and scanned horizontally onto a screen 270. One image frame may be projected with one revolution of the optical scanning device. Here, although the scanning direction is illustrated as being from left to right (the direction of the arrow), it is apparent that images may be scanned in other directions (e.g. in the opposite direction).

The present invention is applicable to a display apparatus having a one dimensional diffraction type light modulator as described above. Also, the present invention can be applied to a portable device having projector function (for example, mobile phones, PDAs, notebook computers, etc.) in order to reduce power consumption in the portable device.

FIG. 3 is a block diagram of a part of the scanning display apparatus.

Referring to FIG. 3, an image signal containing image information is inputted to the image control part 150. The inputted image signal is sent to an image correction part 322 by an image signal input part 321, and is composed of R, G, B digital data and a timing signal. Then, the image correction part 322 corrects the received image signal according to a deviation between elements. The image correction part 322 is connected with an outside memory 330, so that it reads initial setting value and performs a correction process according to a correction logic.

An image data synchronization signal output part 325 changes the order of data inputted in row by row order such that the data is outputted in column by column order, and sends a synchronization signal per frame, a pixel synchronization signal and a vertical line output timing signal, etc. to a the driving circuit 125.

The driving circuit 125 converts digital image data to analog signals for operating panels, and operates the light modulator 120 in synchronization with the vertical line output timing signal. Also, the driving circuit 125 matches the gradation of image to an output voltage level by referring to an analog voltage range determined in an upper electrode voltage range control part 323.

The light modulator 120 deforms its micromirrors due to a voltage difference between an upper electrode and a lower electrode (to which voltage is supplied by a lower electrode voltage control part 324), thereby adjusting the intensity of incident light from a light source 110.

A scanner output control part 326 outputs a position control signal (namely, the scanner control signal) of the scanner 130 to a scanner driver 360 in synchronization with the vertical line output timing signal. A memory 330 stores correction values (per pixel, per color) for the image correction part 322, a voltage range for the upper electrode, an initial setting value for the lower electrode, a scanning profile and an output setting value for the light source.

The scanner output control part 326 reads a position value as a digital value from the scanning profile stored in the memory 330, and outputs the value to the scanner driver 360, which converts the inputted digital value to an analog value, and provides the analog value to the scanner 130, thereby controlling the position of the scanner 130.

A light source output control part 327 includes a light source output regulation block and a light source timing regulation block. The light source output regulation block regulates the power of the red light source 110R, the green light source 110G and the blue light source 110B. The light source timing regulation block turns on sequentially each of the color light sources 110R, 110G, 110B.

A light source control signal generated by the light source regulation block and the light source timing regulation block is delivered to the color light source drivers 350R, 350G and 350B. The light source control signal includes control signals for the red, green and blue light sources, and each control signal contains information on output and timing (turnon start time, turnon maintenance time, etc.) for the corresponding color light source, so that each color light source driver 350R, 350G, 350B controls the power and the on/off of the corresponding light source.

In the present invention, a sub frame refers to a monotone frame constituting a full color frame. A pixel can represent a full color by means of red, green and blue image data. Accordingly, by displaying the sub frames in red, green or blue color at the same time or sequentially within a short time, a full color frame can be generated.

In the case that a color frame has an input frequency of F, a 3 sub frame scanning display apparatus inputs the subframes in a frequency of 3F in order to prevent flicker. Every three subsequent subframes are composed of red, green and blue subframes.

In the case of a four sub frame scanning display apparatus, one frame is composed of red, green and blue subframes, and also one more subframe in any of the three colors. That means each subframe has an input frequency of 4F, when a color frame has an input frequency of F.

Hereinafter, are described a three subframe scanning displaying method and a four subframe scanning displaying method.

FIG. 4 illustrates a three subframe scanning display method that has variable output time according to color. In the following example, the scanner 130 is a galvano mirror that conducts scanning in two directions by rotating clockwise and counter-clockwise, and accordingly the description focuses on a two direction scanning display method. However, it is apparent that the invention can also be applied to a single direction scanning display method.

Modulated light from the light modulator 120 is reflected by the scanner 130 rotating clockwise, so that vertical one dimensional images in red are consecutively scanned on the screen from the right to the left (←), generating a two dimensional red subframe 140R of an Nth color frame 400(N).

Next, the scanner 130 rotates counter-clockwise, scanning vertical one dimensional liner images in green onto the screen from the left to the right (→), so that a two dimensional green subframe 140G of the Nth color frame is generated.

Subsequently, the scanner 130 rotating clockwise scans vertical one dimensional linear images in blue onto the screen from the right to the left (←), generating a two dimensional blue subframe 140B of the Nth color frame 400(N) The order of colors can be changed as long as each color subframe is displayed at least once to generate the Nth color frame 400(N).

In the same process, two dimensional red, green and blue subframes for an (N+1)th frame are displayed by the scanner 130.

FIG. 5 is a diagram showing signals applied to a scanner and a light source in the conventional three subframe scanning display method, and FIG. 6 is a diagram showing signals applied to a scanner and a light source in an embodiment of the present invention. It is assumed that an image signal in the embodiment has a frequency of 75 Hz.

Referring to FIG. 5, the same power P1 is required of red, green and blue light sources for displaying a color frame, and the output time Tr, Tg, Tb of the red, green and blue light sources is also the same. The output time of the light source is less than 1/(75×3) [sec]. There is a blank time Tz during which no output is produced by none of the light sources. The blank time is a time required for the scanner 130 to change its rotation direction.

However, due to manufacturing process and color temperature of a frame, the light sources actually do not produce output with the same power and for the same output time as described in FIG. 5.

For example, when the green light source generates power P2 lower than the required power P1, the total output is influenced by the low output. Therefore, one of the purposes of the present invention is to overcome this problem.

As shown in FIG. 6, the output time for the green light source, of which power is P2, is extended to Tg′ (wherein Tg′>Tg), and instead the power of the red light source is raised to P3 from P1 in order to compensate a decrease in the output time of the red light source. Therefore, the total output increases as much as the output increase of the green light source due to the output time extension, thereby generating brighter image.

At least one of the three light sources has different output time. Each color subframe has the same number of columns, each of which represents one vertical one dimensional linear image scanned in horizontal direction. This number of columns is called the horizontal resolution Hres.

The output period Tor, Tog, Tob of the vertical one dimensional linear image can be obtained dividing the output time per color by the horizontal resolution as shown the following formula:

(Tor, Tog, Tob)=(Tr′, Tg′, Tb′)/Hres [Formula 1]

The image control part 150 adjusts the output period of the image data according to Formula 1, whenever the color to be displayed on screen 140 is changed. The driving circuit 125 is informed of this adjusted output period by the image data synchronization signal output part 325.

The image control part 150 may adjust the point of time Tir, Tig, Tib when the image data of the subframe is first outputted. Since the scanner 130 spends different scanning time according to color, the point of time Tir, Tig, Tib when the image data for a new subframe is first outputted should be adjusted.

The image control part 150 generates the scanner control signal to control the scanner 130 to rotate clockwise or counterclockwise in correspondence with the output time of each color. More specifically, the scanner control signal is sent from the scanner output control part 326 to the scanner driver 360, thereby controlling the rotation angle of the scanner 130.

The scanner 130 rotates within a range from A0 to A3. Within the range from A1 to A2, effective image is scanned to the screen 140. During the sections corresponding to between A0 and A1 and between A2 and A3, the scanner 130 changes its driving direction, so that no effective image is outputted.

Assuming that the scanner 130 rotates clockwise from A1 to A2, it rotates counterclockwise from A2 to A1. The opposite is also true.

FIG. 7 shows a four subframe scanning display method that has variable output time according to color. In the following example, the scanner 130 is a galvano mirror that conducts scanning in two directions by rotating clockwise and counter-clockwise, and accordingly the description focuses on a two direction scanning display method. However, it is apparent that the invention is also applicable to a single direction scanning display method.

Modulated light from the light modulator 120 is reflected by the scanner 130 rotating clockwise, so that vertical one dimensional images in red are consecutively scanned on the screen from the right to the left (←), generating a two dimensional red subframe 140R of an Nth color frame 600(N).

Next, the scanner 130 rotates counter-clockwise, scanning vertical one dimensional liner images in green onto the screen from the left to the right (→), so that a two dimensional green subframe 140G of the Nth color frame 600(N) is generated.

Subsequently, the scanner 130 rotating clockwise scans vertical one dimensional linear images in blue onto the screen from the right to the left (←), generating a two dimensional blue subframe 140B of the Nth color frame 600(N).

After that, the scanner 130 rotating clockwise scans vertical one dimensional linear images in any of red, green and blue colors (preferably, the color of the light source having the weakest power) consecutively onto the screen from the left to the right (→), generating a two dimensional monotone subframe 140M of the Nth color frame.

The order of colors can be changed as long as each color subframe is displayed at least once to generate the Nth color frame 600(N).

In the same process, two dimensional red, green and blue subframes for an (N+1)th frame are displayed by the scanner 130.

FIG. 8 is a diagram showing signals applied to a scanner and a light source in the typical four subframe scanning display method, and FIG. 9 is a diagram showing signals applied to a scanner and a light source in an embodiment of the present invention. It is assumed that an image signal in the embodiment has a frequency of 60 Hz.

Referring to FIG. 8, the same power P1 is required of red, green and blue light sources for displaying a color frame, and the output time of the red, green and blue light sources is also the same. And, the subframe in one of the three colors (preferably, the color of the light source having the weakest power) is displayed once more in the same color frame. In this embodiment, it is assumed that the blue color subframe is displayed once more.

The output time of the light source is less than 1/(60×4) [sec]. There is a blank time Tz during which no output is produced by none of the light sources. The blank time is a time required for the scanner 130 to change its rotation direction.

For example, when the green light source generates power P2 lower than the required power P1, the total output for the color frame is reduced by the low output. Therefore, one of the purposes of the present invention is to overcome this problem.

As shown in FIG. 6, the output time for the green light source, of which power is P2, is extended to Tg′ (wherein Tg′>Tg), and instead the power of the red light source is raised to P3 from P1 in order to compensate a decrease in the output time of the red light source. Therefore, the total output increases as much as the output increase of the green light source due to the output time extension, thereby generating brighter image.

At least one of the three light sources has different output time. Each color subframe has the same number of columns, each of which represents one vertical one dimensional linear image scanned in horizontal direction. This number of columns is called the horizontal resolution Hres.

The output period Tor, Tog, Tob1, Tob2 of the vertical one dimensional linear image can be obtained dividing the output time per color by the horizontal resolution as shown the following formula:

(Tor, Tog, Tob1, Tob2)=(Tr′, Tg′, Tb1′, Tb240 )/Hres [Formula 2]

The image control part 150 adjusts the output period of the image data according to Formula 2, whenever the color to be displayed on screen 140 is changed. The driving circuit 125 is informed of this adjusted output period by the image data synchronization signal output part 325.

The image control part 150 may adjust the point of time Tir, Tig, Tib1, Tib2 when the image data of the subframe is first outputted . Since the scanner 130 spends different scanning time according to color, the point of time Tir, Tig, Tib1, Tib2 when the image data for a new subframe is first outputted should be adjusted.

The image control part 150 generates the scanner control signal to control the scanner 130 to rotate clockwise or counterclockwise in correspondence with the output time of each color. More specifically, the scanner control signal is sent from the scanner output control part 326 to the scanner driver 360, thereby controlling the rotation angle of the scanner 130.

The scanner 130 rotates within a range from A0 to A3. Within the range from A1 to A2, effective image is scanned to the screen 140. During the sections corresponding to between A0 and A1 and between A2 and A3, the scanner 130 changes its driving direction, so that no effective image is outputted.

Assuming that the scanner 130 rotates clockwise from A1 to A2, it rotates counterclockwise from A2 to A1. The opposite is also true.

FIG. 10 is a flowchart of a scanning display method according to an embodiment of the present invention in which the output time of the light source is variable.

At step S1010, the image control part 150 selects a mono-color light source limiting the brilliance of a two dimensional color image among a plurality of mono-color light sources 110R, 110G and 110B by comparing maximum effective power and power demand of each mono-color light source, the detail of which will be described later with reference to FIGS. 11 and 12.

At step S1020, the output time of the selected mono-color light source is extended, and the output time of the other mono-color light sources is reduced, such that the total output time for a color frame remains the same. When the output time of one mono-color light source is extended by A, then the sum of reduced output time of the other mono-color light sources is A.

At step S1030, in accordance with the adjusted output time, a light source control signal, an image control signal and a scanner control signal are produced. The light source control signal controls the mono-color light sources of which output time is reduced to raise its power by a rate corresponding to the decrease of the output time. The image control signal controls the point of time when image data on a color corresponding to each mono-color light source starts to be outputted, and the output period of the image data by using the output time of each mono-color light source. The scanner control signal the rotation angle and the rotation velocity of the scanner in accordance with the output time of each mono-color light source.

At step S1040, a two dimensional color image is display on the screen by controlling each mono-color light source, the light modulator and the scanner by using the light source control signal, the image control signal and the scanner control signal.

FIG. 11 shows tables in which the light efficiency is compared before and after the three subframe scanning display method having variable output time according to color is applied. The unit is mW.

(I) When the maximum power of R,G,B is 40, 100, 50, and the power demand is 69, 56, 53, respectively,

In the case that the present invention is not applied, each light source is turned on for a third of the total output time, because the light sources are alternately turned on each once in order to generate one color frame. Therefore, a first maximum effective power (=the maximum power of each light source/3) is 13.33, 33.33, and 16.67.

In the mean time, since the ratio of the power demand of R,G,B is 69:56:53, a first effective power limit is limited, due to the red light source, to 13.33 for R, 10.82(=13.33×56/69) for G, and 10.24(=13.33×53/69) for blue. Accordingly, the total power output is 34.39(=13.33+10.82+10.24).

According to an embodiment of the present invention, the output time of the red light source is extended by 20%, and the output time of the red and green light sources is each reduced by 10%. Under this condition, a second maximum effective power (=the first maximum effective power×the ratio of increase/decrease of the output time) is 16.00(=13.33×1.2), 30.00(=33.33×0.9), 15.00(=16.67×0.9).

In the mean time, since the ratio of the power demand of R,G,B is 69:56:53, a second effective power limit becomes 16.00 for R, 12.99 (=16.00×56/69) for G, and 12.29(=16.00×53/69) for B. Accordingly the total output power is 41.28(=16.00+12.99+12.29), which means a 20% (=(41.28/34.39−1)×100) increase in the total output power.

(II) When the maximum power of R,G,B is 40, 100, 50, and the power demand is 79, 56, 53, respectively,

A first maximum effective power (=the maximum power of each light source/3) is 13.33, 33.33, and 16.67.

Under the condition that each light source has an equal output time, since the ratio of the power demand of R,G,B is 79:56:53, a first effective power limit is limited, due to the red light source, to 13.33 for R, 9.45(=13.33×56/79) for G, and 8.95(=13.33×53/79) for blue. Accordingly, the total power output is 31.73(=13.33+9.45+8.95).

According to an embodiment of the present invention, the output time of the red light source is extended by 20%, and the output time of the blue and green light sources is each reduced by 10%. Under this condition, a second maximum effective power (=the first maximum effective power×the ratio of increase/decrease of the output time) is 16.00(=13.33×1.2), 30.00(=33.33×0.9), 15.00(=16.67×0.9).

In the mean time, since the ratio of the power demand of R,G,B is 79:56:53, a second effective power limit becomes 16.00 for R, 11.34(=16.00×56/79) for G, and 10.73(=16.00×56/79) for B. Accordingly the total output power is 38.08(=16.00+11.34+10.73), which means a 20% %(=(38.08/31.73−1)×100) increase in the total output power.

(III) When the maximum power of R,G,B is 80, 100, 50, and the power demand is 63, 58, 54, respectively,

A first maximum effective power (=the maximum power of each light source/3) is 26.67, 33.33, and 16.67.

Under the condition that each light source has an equal output time, since the ratio of the power demand of R,G,B is 63:58:54, a first effective power limit is limited, due to the blue light source, to 19.44(=16.67×63/54) for R, 17.90(=16.67×58/54) for G, and 16.67 for B. Accordingly, the total power output is 54.01(=19.44+17.90+16.67).

According to an embodiment of the present invention, the output time of the blue light source is extended by 20%, and the output time of the red and green light sources is each reduced by 10%. Under this condition, a second maximum effective power (=the first maximum effective power×the ratio of increase/decrease of the output time) is 24.00(=26.67×0.9), 30.00(=33.33×0.9), 20.00(=16.67×1.2).

In the mean time, since the ratio of the power demand of R,G,B is 63:58:54, a second effective power limit becomes 23.33(=20.00×63/54) for R, 21.48(=20.00×58/54) for G, and 20.00 for B. Accordingly the total output power is 64.81(=20.00+23.33+21.48), which means a 20%(=(64.81/54.01−1)×100) increase in the total output power.

Based on the above results, it can be concluded that an about 20% increase of brilliance is expected by applying the present invention to the three subframe scanning display method.

FIG. 12 shows tables in which the light efficiency is compared before and after the four subframe scanning display method having variable output time according to color is applied. The unit is mW.

(I) When the maximum power of R,G,B is 40, 100, 50, and the power demand is 69, 56, 53, respectively,

It is assumed that the red light source, which is the weakest light source, is turned on twice to generate a color frame.

The green and blue light sources are turned on each once for a fourth of the total output time, and the red light source is turned on twice for a half of the total output time. Therefore, a first maximum effective power is 20.00, 25.00 and 12.50.

Under the condition that each light source has an equal output time, since the ratio of the power demand of R,G,B is 69:56:53, a first effective power limit is limited, due to the blue light source, to 16.27(=12.50×69/53) for R, 13.21(=12.50×56/53)for G, and 12.50 for B. Accordingly, the total power output is 41.98(=12.50+16.27+13.21).

According to an embodiment of the present invention, the output time of the blue light source is extended by 10%, and the output time of the green light sources is each reduced by 10%. Under this condition, a second maximum effective power (=the first maximum effective power×the ratio of increase/decrease of the output time) is 20.00(=20.00), 22.50(=25×0.9), 13.75(=12.50×1.1) in the order of R, G and B.

In the mean time, since the ratio of the power demand of R,G,B is 69:56:53, a second effective power limit becomes 17.90(=13.75×69/53) for R, 14.53(=13.75×56/53) for G, and 13.75 for B. Accordingly the total output power is 46.18(=13.75+17.90+14.53), which means a 10%(=(64.81/54.01−1)×100) increase in the total output power.

In the same manner, it can be concluded that an about 10% increase of brilliance is expected by applying the present invention to a four subframe scanning display method.

While the invention has been described with reference to the disclosed embodiments, it is to be appreciated that those skilled in the art can change or modify the embodiments without departing from the scope and spirit of the invention or its equivalents as stated below in the claims.

What is claimed is:

1. A scanning display apparatus capable of adjusting an output time of a light source, the apparatus comprising:
a light modulator configured to modulate incident light in accordance with a driving signal and output modulated light corresponding to a one-dimensional linear image;
a driving circuit configured to convert an inputted image control signal to the driving signal and send the driving signal to the light modulator;
a scanner configured to scan modulated light from the light modulator onto a screen by rotating in accordance with a scanner control signal, thereby displaying a two-dimensional color image;
a plurality of mono-color light sources configured to provide the light modulator with the incident light;
a plurality of light source output control parts configured to control an output power and an output time of the mono-color light source in accordance with a light source control signal; and
an image control part configured to receive an image signal, provide the light source output control part with the light source control signal, and provide the scanner and the driving circuit with the scanner control signal and the image control signal, thereby controlling an image projection by the light modulator, the light source control signal controlling the output power and the output time of one or more of the plurality of mono-color light sources, and the scanner control signal and the image control signal being synchronized with the light source control signal.

2. The apparatus of claim 1, wherein the mono-color light source produces one color among red, green, and blue.

3. The apparatus of claim 1, wherein the mono-color light source produces one color among four different colors.

4. The apparatus of claim 1, wherein the image control part comprises:
an image data synchronization signal output part configured to generate and output the image control signal, the image control signal deciding an output starting time and an output period of the image data for each color in correspondence with the image signal and the output power of the plurality of mono-color light sources;
a light source output control part configured to output the light source control signal controlling the output power and turning on and turning off of the plurality of mono-color light sources in correspondence with the output starting time and the output period of the image data for each color; and
a scanner output control part configured to output the scanner control signal in correspondence with the output starting time and the output period of the image data for each color, the scanner control signal controlling a rotation angle and a rotation velocity of the scanner.

5. The apparatus of claim 4, wherein the image data synchronization signal output part keeps the total of the output times of the plurality of mono-color light sources constant by relatively increasing the output time of the mono-color light source outputting a relatively lower output power among the plurality of mono-color light sources, and decreasing the output time of the other mono-color light sources.

6. The apparatus of claim 5, wherein the image data synchronization signal output part increases the output power of the mono-color light sources, of which the output time is relatively decreased, by a rate corresponding to the decrease of the output time.

7. The apparatus of claim 1, wherein the light modulator comprises:
a plurality of micro-mirrors arranged in a row and configured to reflect the incident light; and
a driving part configured to drive the micro-mirrors according to the driving signal, each micro-mirror being responsible for one pixel of the screen.

8. A scanning display method of displaying a two-dimensional color image on a screen by scanning one-dimensional linear images, the display method comprising:
selecting among a plurality of mono-color light sources a mono-color light source limiting the luminance of the two-dimensional color image;
increasing an output time of the selected mono-color light source and decreasing an output time of other mono-color light sources such that the total output time remains the same;
generating and outputting a light source control signal, an image control signal, and a scanner control signal in correspondence with the output times; and
displaying the two dimensional color image by controlling the plurality of mono-color light sources, a light modulator, and a scanner according to the light source control signal, the image control signal, and the scanner control signal.

9. The display method of claim 8, wherein selecting the mono-color light source comprises selecting a mono-color light source limiting the luminance of the two dimensional color image using maximum effective powers and output power demands of the plurality of mono-color light sources.

10. The display method of claim 8, wherein generating and outputting the light source control signal, the image control signal, and the scanner control signal comprises generating and outputting the light source control signal configured to increase an output power of the mono-color light source, of which an output time is decreased, by a rate corresponding to the decrease in the output time.

11. The display method of claim 8, wherein generating and outputting the light source control signal, the image control signal, and the scanner control signal comprises generating and outputting the image control signal configured to decide an output starting time and output period of an image data of a color corresponding to the mono-color light source, according to the output times.

12. The display method of claim 8, wherein generating and outputting the light source control signal, the image control signal, and the scanner control signal comprises generating and outputting the scanner control signal configured to control a rotation angle and a rotation velocity of the scanner according to the output times.
